(19) United States
(12) Patent Application Publication
(10) Pub. No.: US 2020/0139260 A1
(43) Pub. Date: May 7, 2020

(54) INTERLOCKING BRICK ALLOWING MANUFACTURING VARIANCE

(71) Applicant: Charles J. Kulas, San Francisco, CA (US)

(72) Inventor: Charles J. Kulas, San Francisco, CA (US)

(21) Appl. No.: 16/178,487

(22) Filed: Nov. 1, 2018

(51) Int. Cl. A63H 33/08; A63H 33/10; B33Y 80/00

(52) U.S. Cl. CPC A63H 33/086; B33Y 80/00; A63H 33/101

(57) ABSTRACT

Embodiments generally relate to an interlocking brick design suitable for manufacturing with a 3D printer or other type of additive manufacturing. In one embodiment, a top cone having a slightly increasing diameter is formed on a top surface of an interlocking brick or other part. Another embodiment uses a bottom cylinder with notches formed on a bottom surface. The notches define flexible tabs which can have a thinner wall thickness than the cylinder. A design may use either or both of the top cone and bottom cylinder designs.

### BACKGROUND

Interlocking bricks are a popular construction material for children, and adults; being educational, useful and entertaining. Several brands of interlocking bricks are popular today, most notably Lego® brand interlocking bricks and other brands that may be compatible, or not, with the Lego® brick dimensions. Detachable coupling, or interlocking, of bricks or other compatible parts is typically achieved by pushing a protruding structure into a recession structure (e.g., a top part of a brick into a bottom part of another brick) using slight finger pressure. This causes structures on the two bricks to come into contact with each other and retain the contact by friction of the structures against each other.

The bricks, or other interlocking parts, come in many different shapes, sizes and colors. They are typically made of a molded plastic such as Acrylonitrile butadiene styrene (ABS) plastic, although other suitable plastics or materials can be used. The plastic is typically very stiff compared to forces exerted by a human hand, but is also slightly elastic so that it can be compressed or bent to a human-indiscernable degree and then return to its former dimensions. Tolerances for these parts may be on the order of hundredths or thousandths of a millimeter. These small tolerances are made possible by the accuracy that comes about with their manufacturing process, which is typically achieved by injection molding.

With the rise in popularity of consumer grade 3D printers, it is desirable to create a design for interlocking bricks and parts that can be compatible with the existing designs. However, the accuracy of consumer (or even professional or industrial) 3D printers is not as precise or accurate as the manufacturing methods for the popular mass-marketed interlocking bricks. Thus, it is often not possible to use the traditional design measurements or mechanical features of the mass-marketed bricks as designs for reliably functioning and compatible 3D printed interlocking bricks or other parts.

### SUMMARY

Embodiments generally relate to an interlocking brick design suitable for manufacturing with a 3D printer or other type of additive manufacturing. In one embodiment, a top cone having a slightly increasing diameter is formed on a top surface of an interlocking brick or other part. Another embodiment uses a bottom cylinder with notches formed on a bottom surface. The notches define flexible tabs which can have a thinner wall thickness than the cylinder. A design may use either or both of the top cone and bottom cylinder structures. Variations are possible.

### BRIEF DESCRIPTION OF THE DRAWINGS

FIG. 1 illustrates a 2×4 brick including features of embodiments of the invention;

FIG. 2A is a first drawing of a 2×4 prior art brick including dimensions in millimeters;

FIG. 2B is a second drawing of the 2×4 prior art brick including dimensions in millimeters;

FIG. 2C is a third drawing of a 2×4 prior art brick including dimensions in millimeters;

FIG. 3 shows a first technical drawing of an interlocking brick according to an embodiment;

FIG. 4 shows a second technical drawing of an interlocking brick according to an embodiment;

FIG. 5 shows details of a top cone;

FIG. 6 shows details of a bottom cylinder;

FIG. 7A is a front view of a prior art miniature figure;

FIG. 7B is a side view of the prior art miniature figure of FIG. 7A.

FIG. 8A is a first illustration of a three place miniature figure display stand;

FIG. 8B is a second illustration of a three place miniature figure display stand;

FIG. 8C is a third illustration of a three place miniature figure display stand;

FIG. 8D is a fourth illustration of a three place miniature figure display stand including slots;

FIG. 9A is a first illustration of a four place miniature figure display stand;

FIG. 9B is a second illustration of a four place miniature figure display stand;

FIG. 9C is a third illustration of a four place miniature figure display stand;

FIG. 10A is a first illustration of a five place miniature figure display stand;

FIG. 10B is a second illustration of a five place miniature figure display stand;

FIG. 10C is a third illustration of a five place miniature figure display stand;

FIG. 11A is a first illustration of a seven place miniature figure display stand;

FIG. 11B is a second illustration of a seven place miniature figure display stand;

FIG. 11C is a third illustration of a seven place miniature figure display stand;

FIG. 12A is a first illustration of a circular seven place miniature figure display stand;

FIG. 12B is a second illustration of a circular seven place miniature figure display stand; FIG. 12C is a third illustration of a circular seven place miniature figure display stand;

FIG. 12D is a fourth illustration of a circular seven place miniature figure display stand with slots;

FIG. 12E is a fifth illustration of a circular seven place miniature figure display stand including brick inserts;

FIG. 13A is a first illustration of an 8 place miniature figure display stand;

FIG. 13B is a second illustration of an 8 place miniature figure display stand;

FIG. 13C is a third illustration of an 8 place miniature figure display stand;

FIG. 14A is a first illustration of a 10 place miniature figure display stand;

FIG. 14B is a second illustration of a 10 place miniature figure display stand; and

FIG. 14C is a third illustration of a 10 place miniature figure display stand.

### DETAILED DESCRIPTION

Embodiments described herein are merely illustrative examples showing basic components and other features. It should be apparent that many other variations of these features are possible that can provide additional embodiments that may fall within the scope of the claims. For example, although embodiments presented herein are compatible with the Lego® brand of interlocking brick system, it should be apparent that features described can be adapted for use with any other suitable system. Dimensions, number, type and placement of various structures, or other brick characteristics, may be modified and still achieve suitable results.

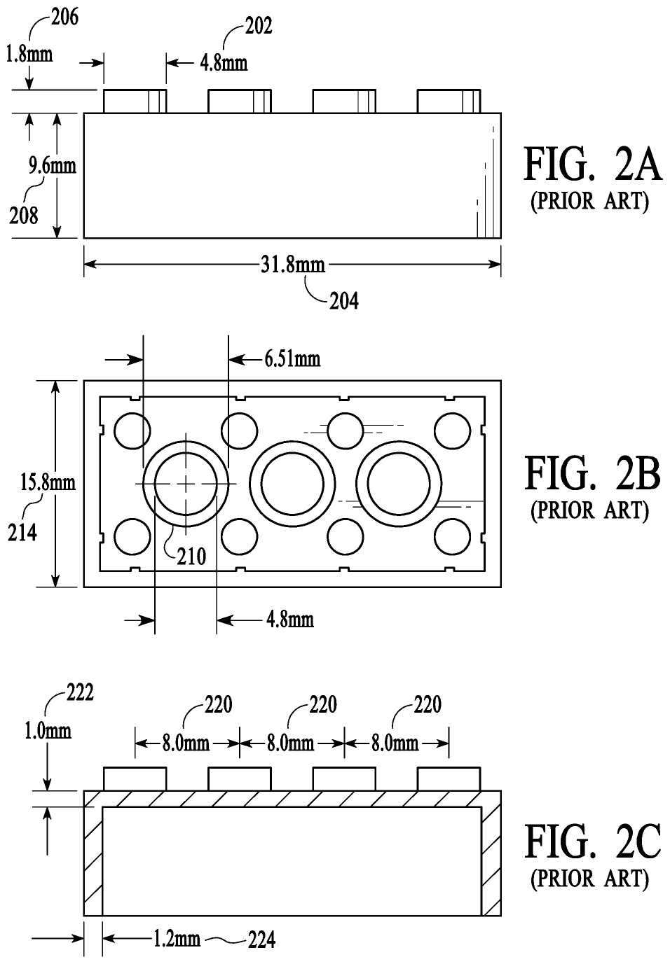

FIG. 2 illustrates dimensions of a prior art standard Lego®, or compatible, basic 2×4 brick. Although references to a particular type or manufacturer may be made, features described herein may be used with different types and manufaturers' products. Different attempts at measuring the same brick may lead to different stated measurements within measuring and manufacturing tolerances of the measuring and/or manufacturing equipment, changes over time to the measuring equipment or brick, changes in temperature, or for other environmental effects or reasons. Other interlocking brick designs may provide the basis for compatible embodiments having features as described herein. In general, unless specific measurements are provided, the embodiments are not limited to particular dimensions.

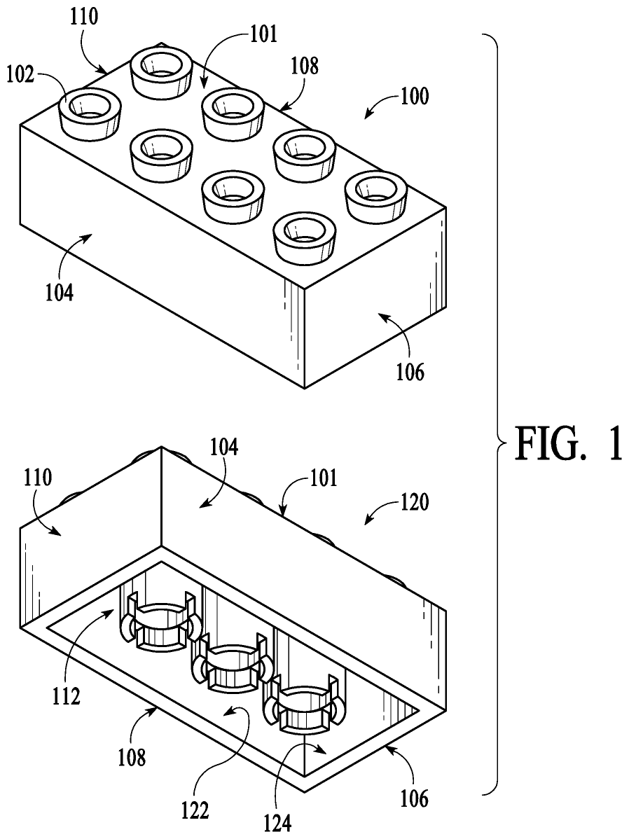

In FIG. 1, top view 100 and bottom view 120, are perspective views of an example interlocking brick according to an embodiment. Although this brick is described as having the top and bottom designs shown in FIG. 2, other embodiments need only include features of either the top or bottom design structure, as desired. It should also be apparent that the size and shape of the brick; and number, size, shape and placement of the top or bottom structures, etc. can vary.

In FIG. 1, top view 100 includes a body made up of sides 101, 104, 106, 108 and 110, to which all other structures are attached. Top side 101 forms a rectangle with four sides normal to it as front side 104, right side 106, back side 108 (not visible) and left side 110 (not visible). As can be seen in bottom view 120, there is not an opposing side to top side 101. In other words, the bottom side of the body structure is open.

Each of the 5 sides has an outer surface and an inner surface. Top view 100 shows the outer surfaces of top side 101, front side 104 and right side 106. Bottom view 120 shows the inner surfaces of back side 108 as inner surface 122, and shows the inner surface 124 of right side 106. In other embodiments, the body design of a brick can vary in dimensions and need not be rectangular.

As shown in FIG. 1 in top view 100, the top surface of top side 101 includes 8 top cones such as 102 fixedly coupled to the top surface. Although difficult to detect from the illustration of FIG. 2 (and as described more clearly in Figures and text, below), each top cone is slightly smaller at its base where it connects to top surface 101 of the body, and is slightly larger at the end of the cone farther away from the body. In other words, the outer radius of the cone end that connects or abuts with body 104 is smaller than the outer radius of the cone end that is distant from body 104. In this embodiment, each cone is identical. In other embodiments, top cones of different dimensions can be used on a same body, brick, or other common structure.

In the embodiment shown in top view 100 of FIG. 1, the top cones are hollowed out. Thus, each top cone has an inner radius and an outer radius. In other embodiments, the amount and shape of hollowing out of the cone can be different from what is depicted in specific measurements herein. The dimensions of top cones on a same body or brick can vary among themselves. Top cones may be solid, without having a hollowed-out interior, or can have other structures within the cones. For example, rather than have no structure (hollow) or a filled structure (solid) other embodiments may employ a cone with a mesh structure within it, cross-beam like structures, etc. Although cones are shown only on a top of a body in FIG. 1, in other embodiments cones may be placed anywhere on a body.

In this embodiment shown in FIG. 1, the cones are placed at the same or approximate positions as the prior art brick of FIG. 2. The larger radius at the far end of the cones means that the cone edges will contact mating surfaces on the bottom of another brick of similar design placed into an interlocking position upon it. The cone's edge surface area is small and it can be elastically deformed by the pressure of another brick's bottom structures to provide frictional interlocking. The conical design also allows a cone structure to adapt to variations in mating dimensions caused by, for example, variances in 3D printed objects. With a hollow cone the thinness of the cone walls helps to allow a flex or bending of the cone walls to help adapt to variances in another brick or structure attempting to be interlocked.

Bottom view 120 illustrates bottom cylinders such as 112. The cylinders are placed in the same or approximate positions as for the prior art brick shown in FIGS. 2A-C. In this embodiment, there are 3 bottom cylinders with positioning and dimensions compatible with the standard prior art brick in FIGS. 2A-C. As discussed in more detail, below, in an embodiment, each cylinder is hollow and includes one or more notches (in this case 4 per cylinder) at the non-attached (far) end of the cylinder. The attached (near) end of the cylinder is the end attached to a surface of the body of the brick. In other embodiments, the number, dimensions and placement of the cylinders can vary. In other embodiments, cylinders need not only be used on the bottom of a brick's body. The brick can vary in shape from the specific embodiments described herein.

The following describe the dimensions of the prior art brick shown in FIGS. 2A-C. Details of prior art bricks may be found in, for example, U.S. Pat. No. 3,005,282 and the like. Particular dimensions may be varied in different embodiments discussed herein. In FIG. 2A, brick length 204 is 31.8 mm. Stud diameter 202 is 4.8 mm. Stud height 206 is 1.8 mm. Brick height 208 is 9.6 mm. In FIG. 2B, brick depth 214 is 15.8 mm. Bottom cylinder 210 has an inner diameter of 4.8 mm and an outer diameter of 6.51 mm. In FIG. 2C, stud spacing 220 is 8.0 mm. Top surface thickness 222 is 1.0 mm. Wall thickness 224 is 1.2 mm.

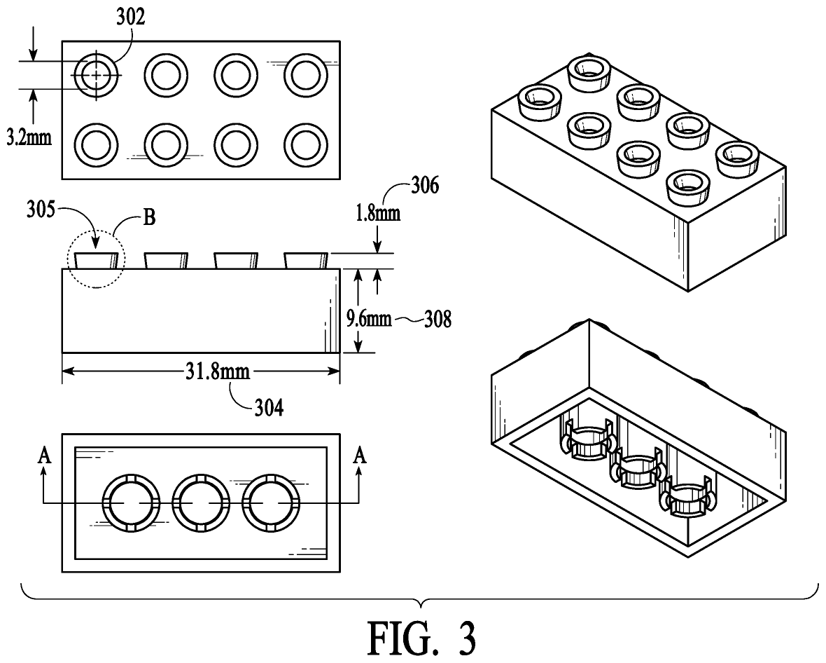

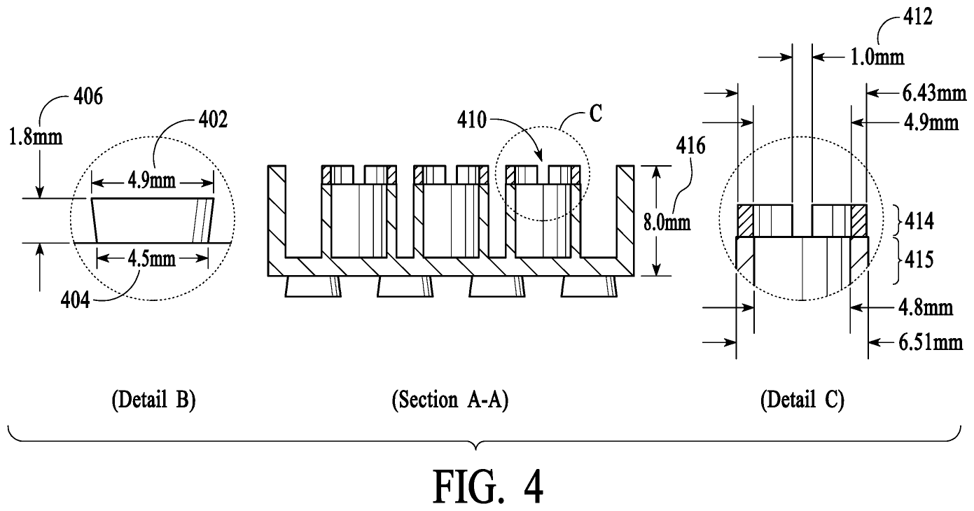

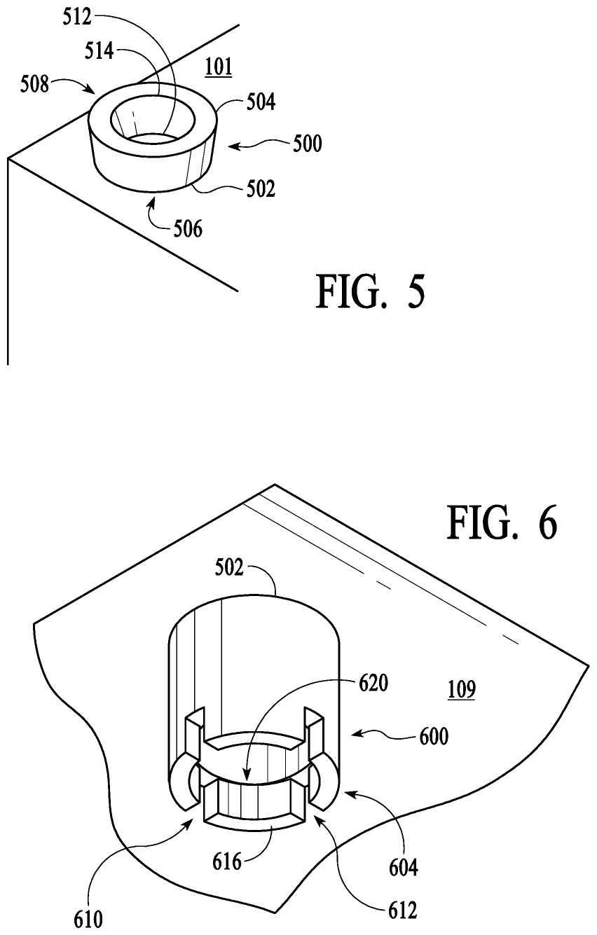

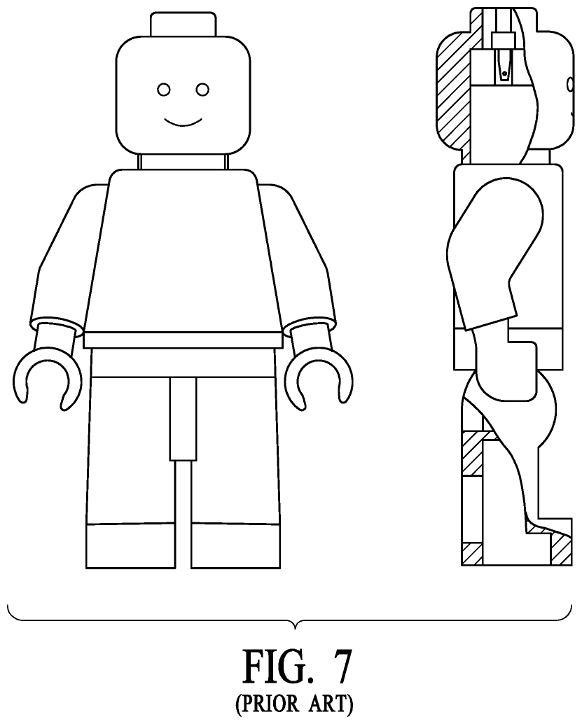

FIGS. 3 and 4 are technical drawings showing the dimensions for a particular embodiment. Dimensions are in millimeters and nuances of these dimensions and the design are further described in enlarged section views shown in FIGS. 5 and 6. The dimensions of FIGS. 3 and 4 are for a particular embodiment that is suitable for printing with Fused Deposition Modeling (FDM) or other additive manufacturing (AM) types of 3D printers. These types of 3D printing techniques typically do not have the precision of mass-manufacturing methods for creating plastic parts, such as interlocking bricks. Because of this, the dimensions of the actual printed brick can vary by hundredths or even tenths of a micron. The dimensions show in in FIGS. 3 and 4 are for a computer modeling of a part for 3D printing. Thus, the dimensions as represented in a computer model or dataset can be exact, but when input to and used by a 3D printer the resulting brick, or other part, will have variances that are typically more than a mass-manufactured brick (as made by a process such as, e.g., injection molding, etc.).

Many different factors in the 3D printing process can affect the dimensions and properties of the 3D printed part including printer calibration, model processing, environmental effects, filament or other printer material composition, thermal variations, cleanliness of the filament path, etc. Because of these variations in the 3D printed part, structures such as the top cones and/or the bottom cylinders can be used to compensate. These structures, especially when used together, can allow a 3D printed brick with variances to still interlock well with other 3D printed bricks, or with mass-manufactured bricks.

FIG. 3 shows a first technical drawing of an interlocking brick according to an embodiment. FIG. 4 shows a second technical drawing of an interlocking brick according to an embodiment. Although particular values are provided in the dimensions in FIGS. 3 and 4, it is possible to achieve useful results by varying the dimensions. This may be especially true where attempts are made to compensate for any of the sources of printing variances as described above. Such varying of the dimensions may be at a first range of + or −2%. A second range can allow variances of + or −5%. A third variance can be + or −10%. Other variance values are possible. One approach to achieving better interlocking of bricks is to vary the dimensions after printing and testing a brick in an iterative process until the fit is sufficient for a particular set of printing factors. Sets of printing factors can be compiled and made available, for example, based on different printers, filaments, model slicers, extruder dimensions, etc.

In general, the measurements and other characteristics of the bricks described herein are for digital models of the bricks to be printed. The digital models can be described in any suitable computer aided design (CAD) or 3D modeling software program. The output of these programs is a digital file in any one of numerous popular formats such as step, 3ds, blend, ipt, obj. Typically the digital file undergoes additional processing before it can be sent to a 3D printer for printing. The file that is generated to go to a 3D printer, again, can be in any of numerous formats such as stl, amf, x3d, obj, etc. Because of the various factors affecting 3D printing, even if a 3D printer gets the same file a slightly different part will be printed. Indeed, even if the same printer prints a same file the two parts will often be different in a non-negligible way. Because of this, attempts at merely printing the prior art blocks according to their dimensions often yields unsatisfactory results.

FIG. 5 illustrates top cone 500 fixedly attached to top surface 101 which makes up one of the sides of a body, brick or other structure. Top cone 500 includes two pairs of radii to define a ring at connected end 506 and at far end 508. Connected end 506 includes a connected end outer radius defining outer circle 502 and a connected end inner radius defining inner circle 512. Similarly, far end 508 includes a pair of radii to define far end outer circle 504, and far end inner circle 514.

In FIG. 3, brick, dimensions are the same as for the prior art brick described in FIGS. 2A-C as length 304 at 31.8 mm; brick height 308 at 9.6 mm; stud height (“cone”) at 1.8 mm. Top cones such as 302 each have a cylindrical cutout, or “hollow region,” of 3.2 mm in diameter. In other embodiments, the cutout need not be cylindrical but can be conical or a different shape. Top cone 305 illustrates the cone-segment shape of the “studs” of this embodiment.

In FIG. 4, the cone-segment shape is shown enlarged at Detail B where cone top outer diameter 402 is 4.9 mm, cone bottom 404 has outer diameter 4.5 mm and the cone segment (or simply “cone”) has a height of 1.8 mm. Bottom cylinders such as 410 extend in dimension 416 to 8.0 mm. As shown in Detail C, the slot spacing cutout is 1.0 mm. Each cylinder includes two parts. An upper cylinder part 414 and a lower cylinder part 415. Although in this embodiment these two parts have slightly different dimensions, in other embodiments they may have one or both of the same dimensions. Upper cylinder part 414 has an outer diameter 6.43 mm and inner diameter 4.90 mm. Lower cylinder part 415 (which incorporates the slots) has an outer diameter of 6.51 mm and an inner diameter of 4.80 mm.

In a particular embodiment, the connected end outer radius for circle 502 is smaller than the far end outer radius for circle 504. Hence, the top cone has an outer edge that gets progressively larger the farther the cone extends from the body. In this embodiment, the inner radius is the same at both the connected end and the far end. This means that the wall of the cone is thicker farther away from the body. Other embodiments need not implement this characteristic of having thicker walls farther away from the body, but the wall can instead remain uniform. For some types of extruded materials such as PLA or ABS using a gradually thickening conical wall can provide needed structural support at the far end where most of the stress is placed on the top cone structure since that is the point of contact with bottom structures of other bricks when placed or pressed together to interlock.

FIG. 6 illustrates bottom cylinder 600 fixedly attached to bottom surface 109 of a top side of a brick or other body. In FIG. 6, bottom cylinder 600 includes connected end 602 and far end 604. Far end 604 includes four notches in the walls of the cylinder that create 4 tabs such as 616 that form arcs around the far end of the cylinder. While difficult to see from the illustration, one embodiment provides that the tabs are not the same thickness as the rest of the cylinder. For example, at the point 620 where tab 616 fixedly abuts the cylinder 600, tab 616 is shown to have a slightly thinner wall than cylinder 600 so that a ridge is formed in the interior of the cylindrical structure. In other embodiments, the thicknesses of the tabs and the cylinder wall can be the same. Or the tabs can even be thicker than the cylinder. In the illustrated embodiment, using thinner walls for the tabs can allow the tabs to flex more easily to accommodate variances in 3D printing manufacturing or other variances. One drawback to this is the point at which the tab joins the cylinder is generally weaker than the other points in the structure and if the tabs are made too think they can separate from the cylinder at the point 620.

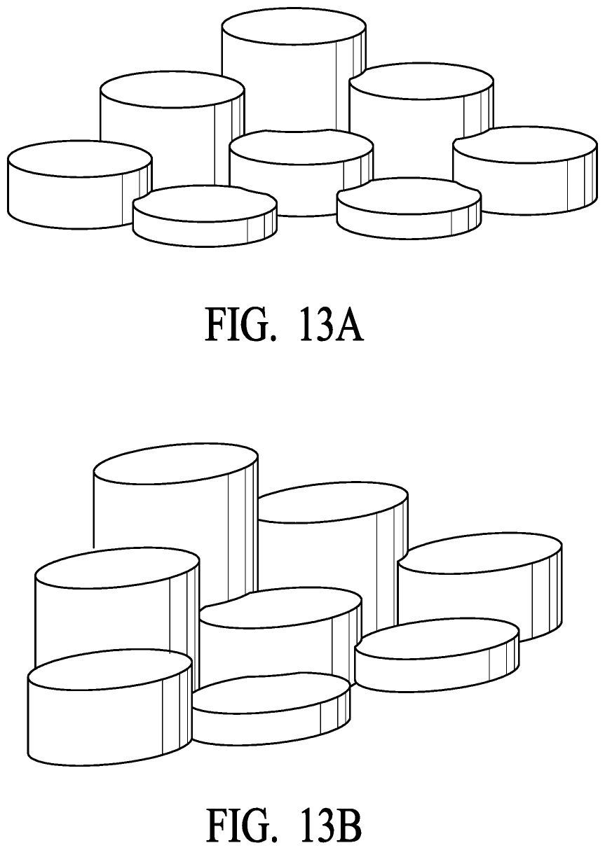

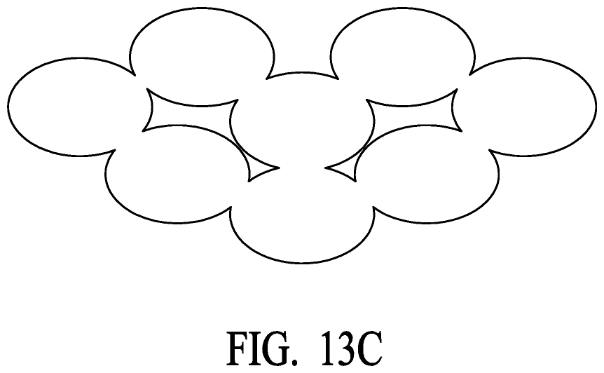

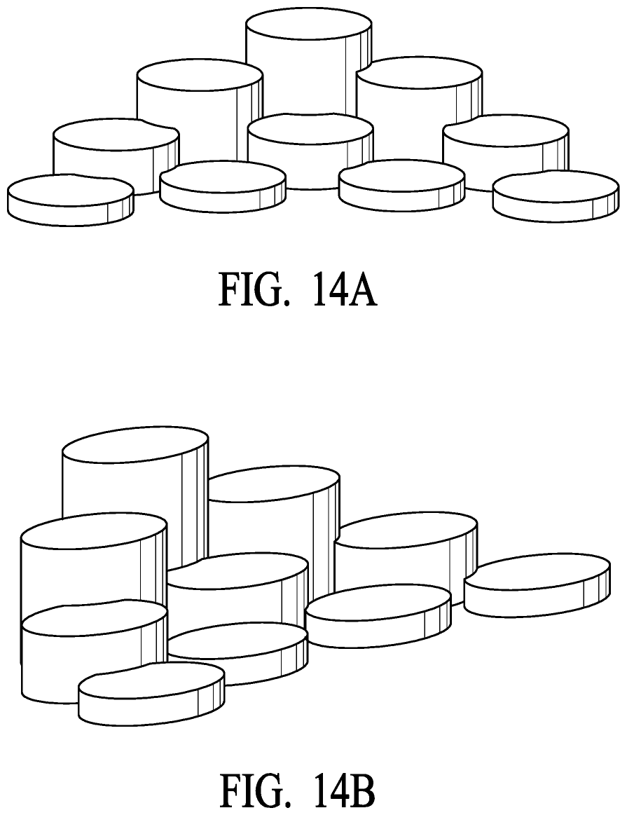

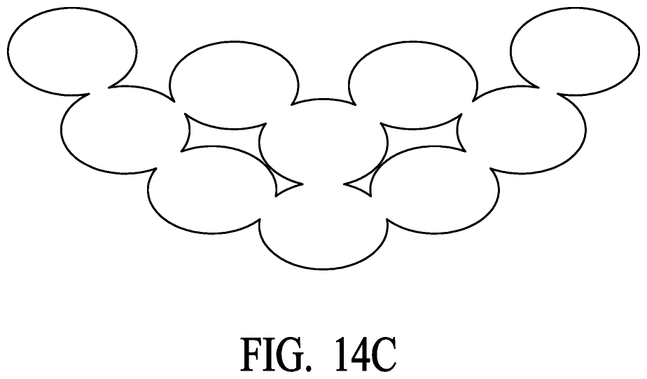

FIGS. 7-14 are next discussed to describe embodiments of display stands that can employ features of the 3D printed interlocking brick design described, above.

FIG. 7 shows a prior art miniature figure, also referred to as a “minifig.” The minifig with dimensions as shown in FIG. 7 is another Lego® or Lego®-compatible design. The dimensions at the bottom of the minifig's feet (and at other positions such as the head, hands, back of legs, etc.) allow detachable coupling, or interlocking, of parts of the minifig with interlocking bricks or other parts or structures—of the type described herein whether it be the various embodiments shown in, e.g., FIGS. 1 and 3-6 or the prior art brick of FIG. 2, or those described in the prior art patents cited above. In general, features described herein can be used with other suitable interlocking parts—such as bricks, minifigs, or other structures—that are presently known or that may be developed in the future.

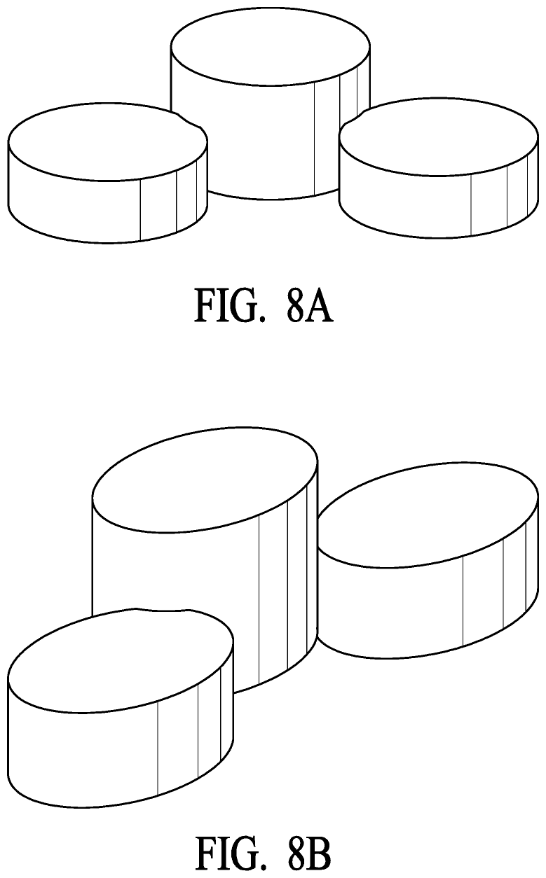

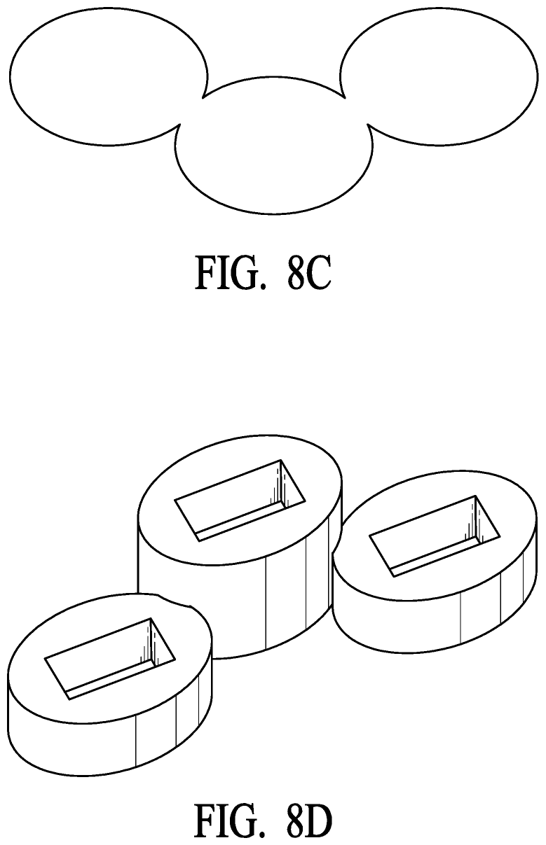

Minifig display stands such as illustrated in FIGS. 8-14 can allow a minifig to be placed onto, or detachably coupled to, a stand. FIGS. 8A-C show a first stand with three oval places. FIG. 8A is a front perspective view of the stand. FIG. 8B is a right-side perspective view of the same stand of FIG. 8A. FIG. 8C is a bottom “footprint” view of the stand of FIGS. 8A and 8B. While the sizes of the stands can be varied, as desired, a particular stand's dimensions that is suitable for use with a minifig of the dimensions of FIG. 7 uses oval shaped place stations where each oval has a major axis of 21.6 mm and a minor axis of 31.2 mm. These are the computer model dimensions which, when modeled in designer software entitled “123D Design” (made by Autodesk® Inc.), pre-processed in Cura software and printed on a Taz® 5 3D printer with PLA filament result in ovals with axes of approximately 21.65 mm and 31.28 mm, respectively.

The overall dimensions of the stand in FIG. 8, comprising the cluster of 3 oval places, is 83.20 mm wide, 32.60 mm deep and 22.00 mm tall. The specific dimensions provide an aesthetically pleasing proportion of stand and places for minifigs generally of the dimensions shown in FIG. 7. However, it should be apparent that other dimensions and proportions are possible. Variances to these dimensions can be made in the range +/−1% to accommodate 3D printer or other manufacturing variables. Another variance in the range +/−2% can be used for manufacturing methods that have larger deviances when printing from the 3D model.

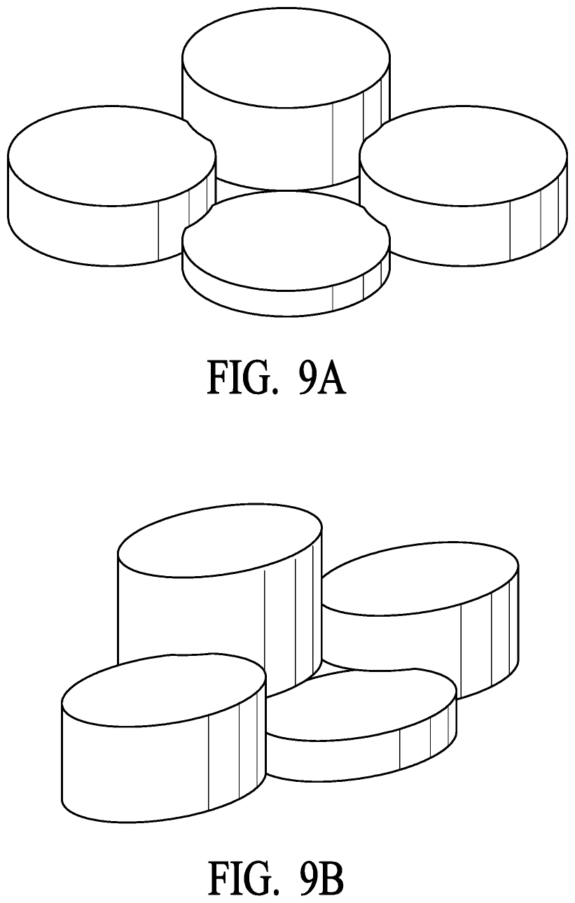

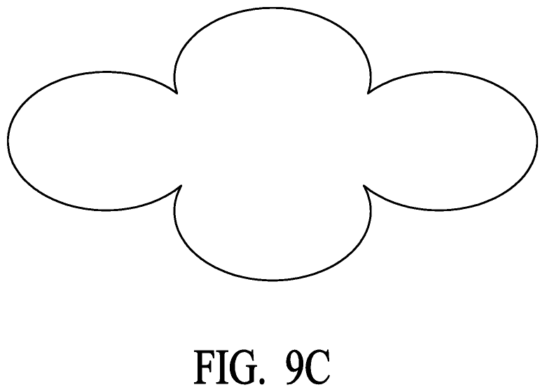

FIG. 8D shows a particular embodiment where cutouts are made at each place in order to accommodate the insertion of a 1×2 interlocking brick. The cutouts are each 17.0 mm long by 8.2 mm wide by 10.0 mm deep. However, for the taller place in the center the cutout is made only 9.5 mm deep. For some reason the 3D printing process using the equipment named, above, introduces a variance in the centermost place pillar, only, requiring the computer model to compensate by adjusting the depth of the center place pillar's cutout by −0.5 mm in order that the bricks, when placed within the cutouts, are substantially flush with the surfaces of the places. This is true for the present design shown in FIG. 8 and for the other designs described in FIGS. 9-14. Other workflows using different hardware and software may not need this particular adjustment, or may need other adjustments. In one embodiment, the cutouts are made centered on their respective oval places.

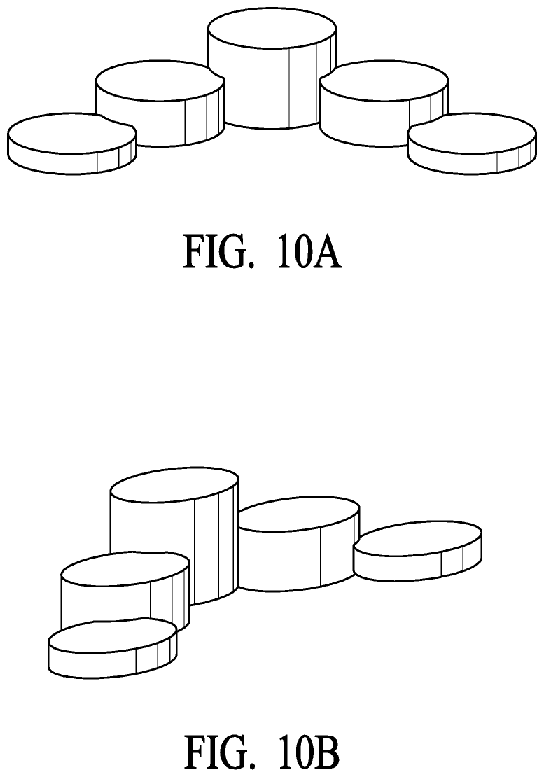

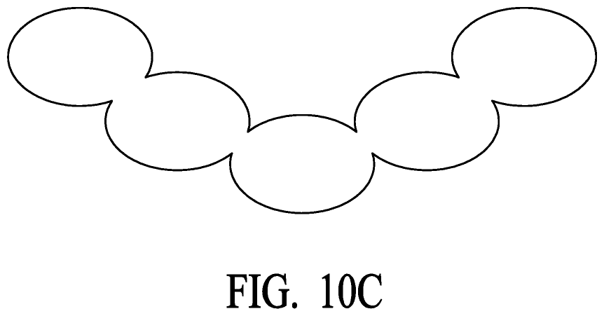

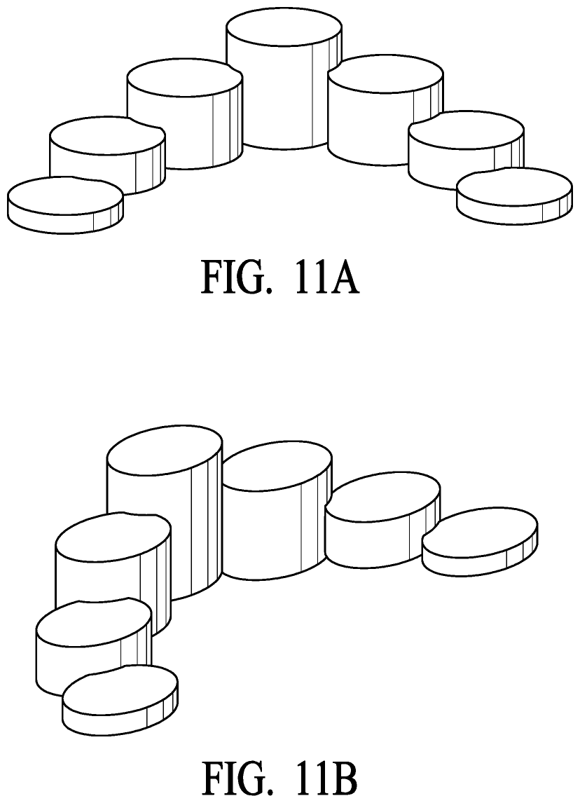

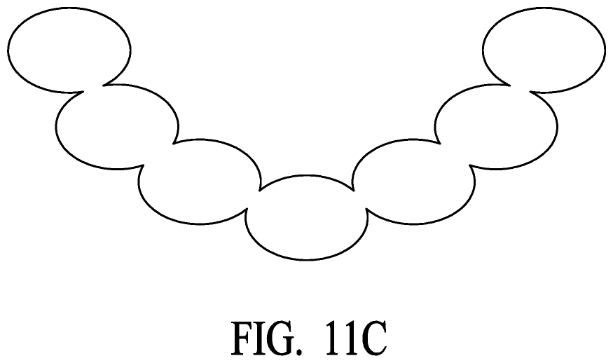

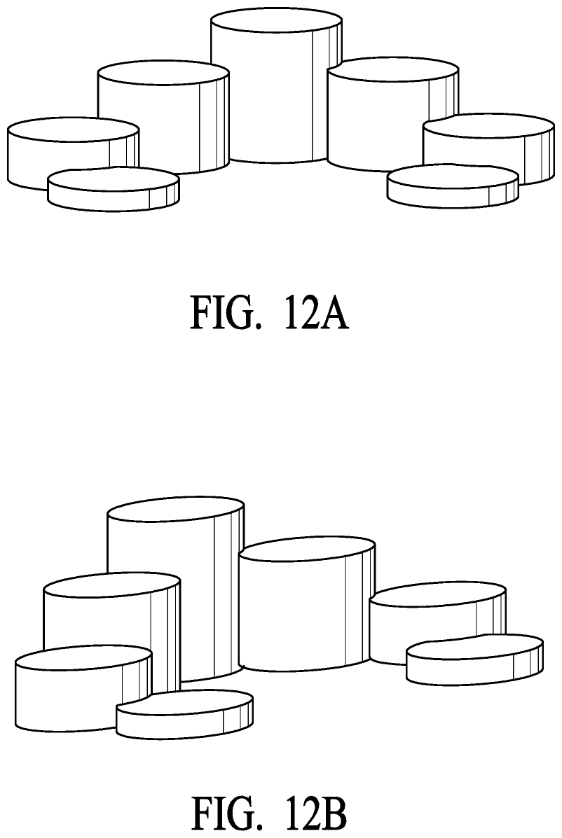

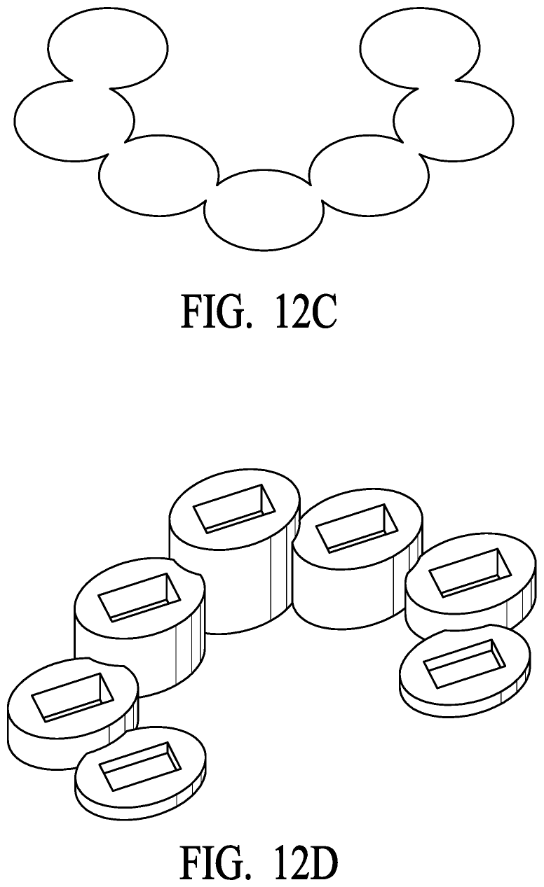

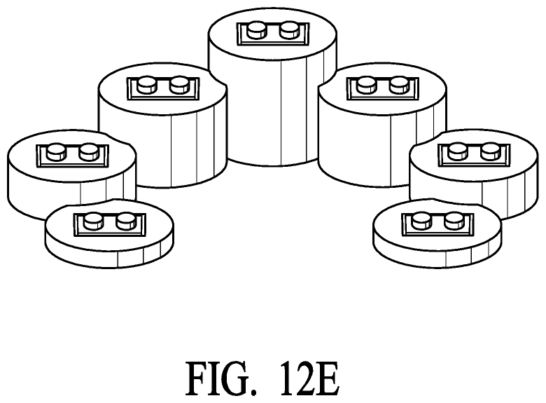

FIGS. 9A-C illustrate another design for a minifig display stand. In FIGS. 9A-C, there are 4 oval places arranged as shown. FIGS. 10A-C show a minifig display stand including 5 oval places arranged in an arc. FIGS. 11A-C show a minifig display stand including seven oval places arranged in an arc. FIGS. 12A-C show a minifig display stand including seven oval places arranged in a partial circle. FIG. 12D shows the stand of FIGS. 12A-C with cutouts. FIG. 12E shows the stand of FIG. 12D with interlocking bricks and plates placed into the cutouts. In FIG. 12E, the shallowest (i.e., least tall) places are not deep enough for standard bricks so, instead, “plates” are used which are similar to the bricks but only ⅓ the height of a brick. In an embodiment, the cutouts are slightly larger than needed to accommodate the bricks and plates to account for variances in 3D printing or other manufacturing methods. If the dimensions of the cutouts with the bricks and plates are close enough, the bricks and plates can be held in place merely by friction. Otherwise, a glue or other adhesion; or other means of securing the bricks and plates to the stand may be used.

Although features have been described with respect to particular embodiments thereof, these particular embodiments are merely illustrative, and not restrictive.

Any suitable programming language may be used to implement the routines of particular embodiments including C, C++, Java, assembly language, etc. Different programming techniques may be employed such as procedural or object-oriented. The routines may execute on a single processing device or on multiple processors. Although the steps, operations, or computations may be presented in a specific order, the order may be changed in particular embodiments. In some particular embodiments, multiple steps shown as sequential in this specification may be performed at the same time.

Particular embodiments may be implemented in a computer-readable storage medium (also referred to as a machine-readable storage medium) for use by or in connection with an instruction execution system, apparatus, system, or device. Particular embodiments may be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms. In general, the functions of particular embodiments may be achieved by any means known in the art. Distributed, networked systems, components, and/or circuits may be used. Communication or transfer of data may be wired, wireless, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that is stored in a machine-readable medium to permit a computer to perform any of the methods described above.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, they are intended to cover various modifications and similar arrangements as would be apparent to those skilled in the art. Therefore, the scope of the appended claims should be accorded the broadest interpretation so as to encompass all such modifications and similar arrangements.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

cylinder designs.

1. An interlocking brick having a body, the body having a top surface and a bottom surface, the brick comprising:
a conical protrusion fixedly attached to the top surface, where the conical protrusion is larger the farther away from the body.

2. The interlocking brick of claim 1, further comprising:
a cylinder fixedly attached to the bottom surface at a connected end, where the cylinder includes a far end opposite to the connected end, where the cylinder includes two or more notches in the far end that form at least one tab.

3. The interlocking brick of claim 1, further comprising:
the conical protrusion fixedly attached to the top surface at a base.

4. The interlocking brick of claim 1, further comprising:
a hollow region within the conical protrusion.

5. The interlocking brick of claim 4, wherein the hollow region comprises a cylinder.

6. The interlocking brick of claim 65, further comprising:
The hollow region in the shape of a cylinder.

7. The interlocking brick of claim 6, further comprising:
The hollow region cylinder having a diameter of 3.2 mm+/−10%.

8. The interlocking brick of claim 1, further comprising:
a cone top outer diameter of 4.9 mm+/−10%.

9. The interlocking brick of claim 1, further comprising:
a cone bottom outer diameter of 4.5 mm+/−10%.

10. An interlocking brick having a body, the body having a top surface and a bottom surface, the brick comprising:
a main cylinder fixedly attached to the bottom surface at a connected end, where the cylinder includes a far end opposite to the connected end, where the cylinder includes two or more notches in the far end that form at least one tab.

11. The interlocking brick of claim 10, wherein an outer diameter of the main cylinder is 6.51 mm+/−10%.

12. The interlocking brick of claim 10, wherein an inner diameter of the main cylinder is 4.8 mm+/−10%.

13. The interlocking brick of claim 10, further comprising:
An upper cylinder part having different dimensions than the main cylinder.

14. The interlocking brick of claim 13, further comprising:
the upper cylinder having an outer diameter of 6.43 mm+/−10%.

15. The interlocking brick of claim 13, further comprising:
the upper cylinder having an inner diameter of 4.9 mm+/−10%.
